(19) United States
(12) Patent Application Publication
(10) Pub. No.: US 2010/0190143 A1
(43) Pub. Date: Jul. 29, 2010

(54) ADAPTIVE TEACHING AND LEARNING UTILIZING SMART DIGITAL LEARNING OBJECTS

(75) Inventors: Michael Gal, Herzliya (IL); Tsila Shalom, Tel Aviv (IL); Dov Weiss, Kiryat-Ono (IL)

Correspondence Address: EITAN MEHULAL LAW GROUP, 10 Abba Eban Blvd. PO Box 2081, Herzlia, 46120, IL

(73) Assignee: TIME TO KNOW LTD.

(21) Appl. No.: 12/360,956

(22) Filed: Jan. 28, 2009

(51) Int. Cl. G09B 7/00

(52) U.S. Cl. 434/322

(57) ABSTRACT

Adaptive teaching and learning utilizing smart digital learning objects. For example, a system for adaptive computerized teaching includes: a computer station to present to a student an interactive digital learning activity based on a structure representing a molecular digital learning object which comprises one or more atomic digital learning objects, wherein at least one action within a first of the atomic digital learning objects modifies performance of a second of the atomic digital learning objects.

### FIELD

Some embodiments are related to the field of computer-based teaching and computer-based learning.

### BACKGROUND

Many professionals and service providers utilize computers in their everyday work. For example, engineers, programmers, lawyers, accountants, bankers, architects, physicians, and various other professionals spend several hours a day utilizing a computer. In contrast, many teachers do not utilize computers for everyday teaching. In many schools, teachers use a “chalk and talk” teaching approach, in which the teacher conveys information to students by talking to them and by writing on a blackboard.

### SUMMARY

Some embodiments include, for example, devices, systems, and methods of adaptive teaching and learning utilizing smart digital learning objects.

In some embodiments, for example, a system for adaptive computerized teaching includes: a computer station to present to a student an interactive digital learning activity based on a structure representing a molecular digital learning object which includes one or more atomic digital learning objects, wherein at least one action within a first of the atomic digital learning objects modifies performance of a second of the atomic digital learning objects.

In some embodiments, for example, a first atomic digital learning object of said molecular digital learning object is to generate an output to be used as an input of a second atomic digital learning object of said molecular digital learning object.

In some embodiments, for example, a first atomic digital learning object of said molecular digital learning object is to generate an output which triggers activation of a second atomic digital learning object of said molecular digital learning object.

In some embodiments, for example, the molecular digital learning object includes a managerial component to handle one or more communications among two or more atomic digital learning objects of said molecular digital learning object.

In some embodiments, for example, the molecular digital learning object is a high-level molecular digital learning object including two or more molecular digital learning objects.

In some embodiments, for example, the system further includes: a computer-aided assessment module to dynamically assess one or more pedagogic parameters of said student, based on one or more logged interactions of said student via said computer station with one or more digital learning objects; and an educational content generation module to automatically generate the structure representing said molecular digital learning object, based on an output of said computer-aided assessment module.

In some embodiments, for example, the educational content generation module is to select, based on the output of said computer-aided assessment module, a digital learning object template, a digital learning object layout, and a learning design script; to create said molecular digital learning object from one or more atomic digital learning objects stored in a repository of educational content items; and to insert digital educational content into said molecular digital learning object.

In some embodiments, for example, the educational content generation module is to activate said molecular digital learning object in a correction cycle performed on said computer station associated with said student.

In some embodiments, for example, the educational content generation module is to automatically insert digital educational content into said molecular digital learning object based on estimated contribution of the inserted digital educational content to topic-related knowledge of said student.

In some embodiments, for example, the educational content generation module is to select said digital educational content based on tagging of atomic digital learning objects with tags of a concept-based ontology.

In some embodiments, for example, the educational content generation module is to select, based on concept-based ontology tags: a digital learning object template, a digital learning object layout, and a learning design script; to generate said molecular digital learning object; and to insert digital educational content into said molecular digital learning object based on estimated contribution of the inserted digital educational content to development of at least one of: a skill of said student, and a competency of said student.

In some embodiments, for example, an apparatus for adaptive computerized teaching includes: a live text module including a multi-layer presenter associated with a text layer and an index layer, wherein the index layer includes an index of said text layer, wherein the multi-layer presenter is further associated with one or more information layers associated with said text, wherein the multi-layer presenter is to selectively present at least a portion of said text layer based on said index layer and based on one or more parameters corresponding to said one or more information layers.

In some embodiments, for example, the live text module includes an atomic digital learning object, and wherein said atomic digital learning object and at least one more atomic digital learning object are included in a molecular digital learning object.

In some embodiments, for example, said atomic digital learning object is able to communicate with said at least one more atomic digital learning object.

In some embodiments, for example, said atomic digital learning object is to be managed by a managerial component of said molecular digital learning object.

In some embodiments, for example, said atomic digital learning object is tagged with one or more tags of a concept-based ontology, and said atomic digital learning object is inserted into said molecular digital learning object based on at least one of said tags.

In some embodiments, for example, the apparatus includes: a text engine to selectively present, using an emphasizing style, a portion of said text layer corresponding to a textual characteristic.

In some embodiments, for example, the apparatus includes: a linguistic navigator to present one or more cascading menus including selectable menu items, wherein at least one of the menu items corresponds to a linguistic phenomena.

In some embodiments, for example, the linguistic navigator is to present a menu including at least one of: a command to emphasize all words in said text layer which meet a selectable linguistic property; a command to emphasize all terms in said text layer which meet a selectable linguistic property; a command to emphasize all sentences in said text layer which meet a selectable linguistic property; a command to emphasize all paragraphs in said text layer which meet a selectable linguistic property; a command to emphasize all text-portions in said text layer which meet a selectable grammar-related property; and a command to emphasize all text-portions in said text layer which meet a selectable vocabulary-related property.

In some embodiments, for example, the linguistic navigator is to present a menu including at least one of: a command to emphasize verbs in said text layer, a command to emphasize nouns in said text layer, a command to emphasize adverbs in said text layer, a command to emphasize adjectives in said text layer, a command to emphasize questions in said text layer, a command to emphasize thoughts in said text layer, a command to emphasize feelings in said text layer, a command to emphasize actions in said text layer, a command to emphasize past-time portions in said text layer, a command to emphasize present-time portions in said text layer, and a command to emphasize future-time portions in said text layer.

In some embodiments, for example, the apparatus includes an interaction generator to generate an interaction between a student utilizing a student station and said text layer.

In some embodiments, for example, the interaction includes an interaction selected from the group consisting of: ordering of text portions, dragging and dropping of text portions, matching among text portions, moving a text portion into a type-in field, and moving into said text layer a text portion external to said text layer.

In some embodiments, for example, a method of adaptive computerized teaching includes: presenting to a student an interactive digital learning activity based on a structure representing a molecular digital learning object which includes one or more atomic digital learning objects, wherein an at least one action within a first of the atomic digital learning objects modifies performance of a second of the atomic digital learning objects.

In some embodiments, for example, a first atomic digital learning object of said molecular digital learning object is to generate an output to be used as an input of a second atomic digital learning object of said molecular digital learning object.

In some embodiments, for example, a first atomic digital learning object of said molecular digital learning object is to generate an output which triggers activation of a second atomic digital learning object of said molecular digital learning object.

In some embodiments, for example, the method includes: operating a managerial component of the molecular digital learning object to handle one or more communications among two or more atomic digital learning objects of said molecular digital learning object.

In some embodiments, for example, the molecular digital learning object is a high-level molecular digital learning object including two or more molecular digital learning objects.

In some embodiments, for example, the method includes: dynamically assessing one or more pedagogic parameters of said student, based on one or more logged interactions of said student via said computer station with one or more digital learning objects; and automatically generating the structure representing said molecular digital learning object, based on an output of said computer-aided assessment module.

In some embodiments, for example, the method includes: based on the results of the assessing, selecting a digital learning object template, a digital learning object layout, and a learning design script; creating said molecular digital learning object from one or more atomic digital learning objects stored in a repository of educational content items; and inserting digital educational content into said molecular digital learning object.

In some embodiments, for example, the method includes: activating said molecular digital learning object in a correction cycle performed on said computer station associated with said student.

In some embodiments, for example, the method includes: automatically inserting digital educational content into said molecular digital learning object based on estimated contribution of the inserted digital educational content to topic-related knowledge of said student.

In some embodiments, for example, the method includes: selecting said digital educational content based on tagging of atomic digital learning objects with tags of a concept-based ontology.

In some embodiments, for example, the method includes: based on concept-based ontology tags, selecting: a digital learning object template, a digital learning object layout, and a learning design script; generating said molecular digital learning object; and inserting digital educational content into said molecular digital learning object based on estimated contribution of the inserted digital educational content to development of at least one of: a skill of said student, and a competency of said student.

Some embodiments may include, for example, a computer program product including a computer-useable medium including a computer-readable program, wherein the computer-readable program when executed on a computer causes the computer to perform methods in accordance with some embodiments.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a teaching/learning system in accordance with some demonstrative embodiments.

FIG. 2 is a schematic block diagram illustration of a teaching/learning data structure in accordance with some demonstrative embodiments.

FIG. 3 is a schematic flow-chart of a method of automated content generation, in accordance with some demonstrative embodiments.

FIG. 4 is a schematic block diagram illustration of a “live text” module in accordance with some demonstrative embodiments.

FIG. 5 is a schematic block diagram illustration of tasks management in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

The terms “plurality” or “a plurality” as used herein include, for example, “multiple” or “two or more”. For example, “a plurality of items” includes two or more items.

Although portions of the discussion herein relate, for demonstrative purposes, to wired links and/or wired communications, some embodiments are not limited in this regard, and may include one or more wired or wireless links, may utilize one or more components of wireless communication, may utilize one or more methods or protocols of wireless communication, or the like. Some embodiments may utilize wired communication and/or wireless communication.

The term “teacher” as used herein includes, for example, an educator, a tutor, a guide, a principal, a permanent teacher, a substitute teacher, an instructor, a moderator, a supervisor, an adult supervising minors, a parent acting in a role of a teacher, a designated student acting in a role of a teacher, a coach, a trainer, a professor, a lecturer, an education-providing person, a member of an education system, a teaching professional, a teaching person, a member of an education system, a teacher that performs teaching activities in-class and/or out-of-class and/or remotely, a person that conveys information or knowledge to one or more students, or the like.

The term “student” as used herein includes, for example, a pupil, a minor student, an adult student, a scholar, a minor, an adult, a person that attends school on a regular or non-regular basis, a learner, a person acting in a learning role, a learning person, a person that performs learning activities in-class or out-of-class or remotely, a person that receives information or knowledge from a teacher, or the like.

The term “class” as used herein includes, for example, a group of students which may be in a classroom or may not be in the same classroom; a group of students which may be associated with a teaching activity or a learning activity; a group of students which may be spatially separated, over one or more geographical locations; a group of students which may be in-class or out-of-class; a group of students which may include student(s) in class, student(s) learning from their homes, student(s) learning from remote locations (e.g., a remote computing station, a library, a portable computer), or the like.

Some embodiments may be used in conjunction with one or more components, devices, systems and/or methods described in U.S. patent application Ser. No. 11/831,981, titled “Device, System, and Method of Adaptive Teaching and Learning”, filed on Aug. 1, 2007, which is hereby incorporated by reference in its entirety.

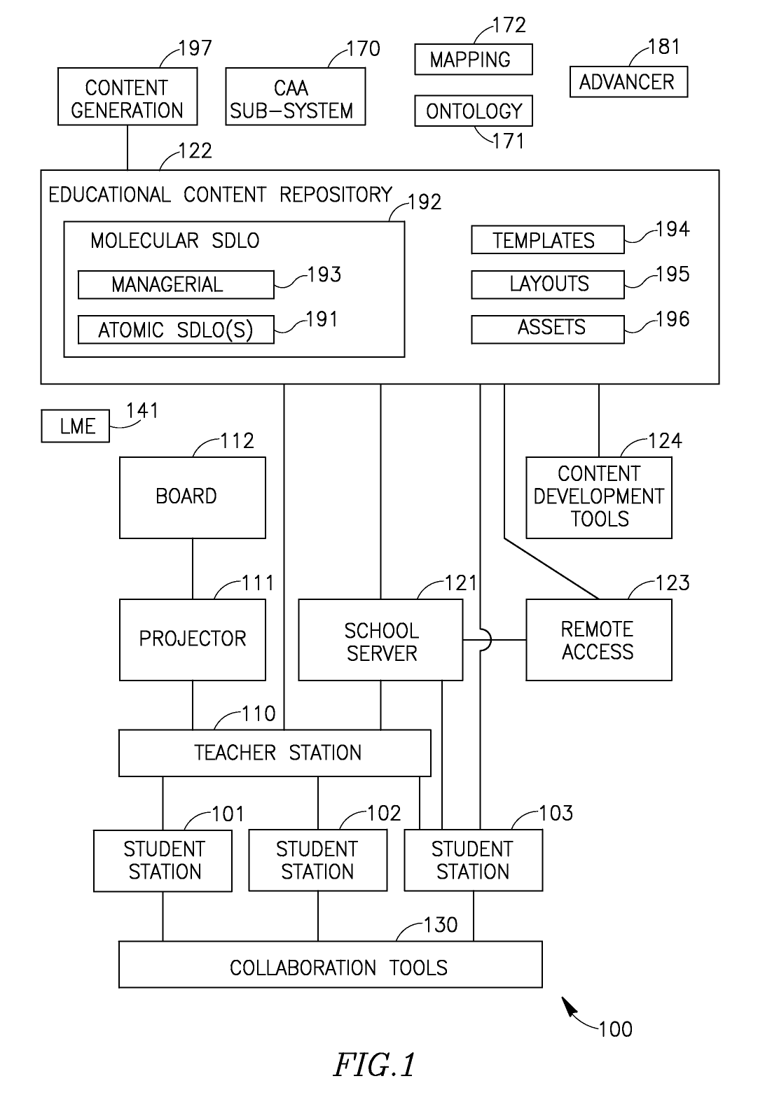

FIG. 1 is a schematic block diagram illustration of a teaching/learning system 100 in accordance with some demonstrative embodiments. Components of system 100 are interconnected using one or more wired and/or wireless links, e.g., utilizing a wired LAN, a wireless LAN, the Internet, and/or other communication systems.

System 100 includes a teacher station 110, and multiple student stations 101-103. The teacher station 110 and/or the student stations 101-103 may include, for example, a desktop computer, a Personal Computer (PC), a laptop computer, a mobile computer, a notebook computer, a tablet computer, a portable computer, a cellular device, a dedicated computing device, a general purpose computing device, or the like.

The teacher station 110 and/or the student stations 101-103 may include, for example: a processor (e.g., a Central Processing Unit (CPU), a Digital Signal Processor (DSP), a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller); an input unit (e.g., a keyboard, a keypad, a mouse, a touch-pad, a stylus, a microphone, or other suitable pointing device or input device); an output unit (e.g., a Cathode Ray Tube (CRT) monitor or display unit, a Liquid Crystal Display (LCD) monitor or display unit, a plasma monitor or display unit, a screen, a monitor, one or more speakers, or other suitable display unit or output device); a memory unit (e.g., a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units); a storage unit (e.g., a hard disk drive, a floppy disk drive, a Compact Disk (CD) drive, a CD-ROM drive, a Digital Versatile Disk (DVD) drive, or other suitable removable or non-removable storage units); a communication unit (e.g., a wired or wireless Network Interface Card (NIC) or network adapter, a wired or wireless modem, a wired or wireless receiver and/or transmitter, a wired or wireless transmitter-receiver or transceiver, a Radio Frequency (RF) communication unit or transceiver, or other units able to transmit and/or receive signals, blocks, frames, transmission streams, packets, messages and/or data; the communication unit may optionally include, or may optionally be associated with, one or more antennas or sets an antennas; an Operating System (OS); and other suitable hardware components and/or software components.

The teacher station 110, optionally utilizing a projector 111 and a board 112, may be used by the teacher to present educational subject matters and topics, to present lectures, to convey educational information to students, to perform lesson planning, to perform in-class lesson execution and management, to perform lesson follow-up activities or processes (e.g., review students performance, review homework, review quizzes, or the like), to assign learning activities to one or more students (e.g., on a personal basis and/or on a group basis), to conduct discussions, to assign homework, to obtain the personal attention of a student or a group of student, to perform real-time in-class teaching, to perform real-time in-class management of the learning activities performed by students or groups of students, to selectively allocate or re-allocate learning activities or learning objects to students or groups of students, to receive automated feedback or manual feedback from student stations 101-103 (e.g., upon completion of a learning activity or a learning object; upon reaching a particular grade or success rate; upon failing to reach a particular grade or success rate; upon spending a threshold amount of attempts or minutes with a particular exercise, or the like), or to perform other teaching and/or class management operations.

In some embodiments, the teacher station 110 may be used to perform operations of teaching tools, for example, lesson planning, real-time class management, presentation of educational content, allocation of differential assignment of content to students (e.g., to individual students or to groups of students), differential assignment of learning activities or learning objects to students (e.g., to individual students or to groups of students), adaptive assignment of content or learning activities or learning objects to students (e.g., based on their past performance in one or more learning activities, past successes, past failures, identified strengths, identified weaknesses), conducting of class discussions, monitoring and assessment of individual students or one or more groups of students, logging and/or reporting of operation performed by students and/or achievements of students, operating of a Learning Management System (LMS), managing of multiple learning processes performed (e.g., substantially in parallel or substantially simultaneously) by student stations 101-103, or the like. In some embodiments, some operations (e.g., logging operations) may be performed by a server (e.g., LMS server) or by other units external to the teacher station 110, whereas other operations (e.g., reporting operations) may be performed by the teacher station 110. In some embodiments, system 100 may include a Learning Management Engine (LME) 141, which may be implemented as part of school server 121 or as a separate component, and may perform one or more of the learning management operations discussed herein.

The teacher station 110 may be used in substantially real time (namely, during class hours and while the teacher and the students are in the classroom), as well as before and after class hours. For example, real time utilization of the teacher station includes: presenting topics and subjects; assigning to students various activities and assignments; conducting discussions; concluding the lesson; and assigning homework. Before and after class hours utilization include, for example: selecting and allocating educational content (e.g., learning objects or learning activities) for a lesson plan; guiding students; assisting students; responding to students questions; assessing work and/or homework of students; managing differential groups of students; and reporting.

The student stations 101-103 are used by students (e.g., individually such that each student operates a station, or that two students operate a station, or the like) to perform personal learning activities, to conduct personal assignments, to participate in learning activities in-class, to participate in assessment activities, to access rich digital content in various educational subject matters in accordance with the lesson plan, to collaborate in group assignments, to participate in discussions, to perform exercises, to participate in a learning community, to communicate with the teacher station 110 or with other student stations 101-103, to receive or perform personalized learning activities, or the like. In some embodiments, the student stations 101-103 may optionally include or utilize software components which may be accessed remotely by the student, for example, to allow the student to do homework from his home computer using remote access, to allow the student to perform learning activities or learning objects from his home computer or from a library computer using remote access, or the like. In some embodiments, student stations 101-103 may be implemented as “thin” client devices, for example, utilizing an Operating System (OS) and a Web browser to access remotely-stored educational content (e.g., through the Internet, an Intranet, or other types of networks) which may be stored on external and/or remote server(s).

The teacher station 110 is connected to, or includes, the projector 111 able to project or otherwise display information on a board 112, e.g., a blackboard, a white board, a curtain, a smart-board, or the like. The teacher station 110 and/or the projector 111 may be used by the teacher, to selectively project or otherwise display content on the board 112. For example, at first, a first content is presented on the board 112, e.g., while the teacher talks to the students to explain an educational subject matter. Then, the teacher may utilize the teacher station 110 and/or the projector 111 to stop projecting the first content, while the students use their student stations 101-103 to perform learning activities. Additionally, the teacher may utilize the teacher station 110 and/or the projector 111 to selectively interrupt the utilization of student stations 101-103 by students. For example, the teacher may instruct the teacher station 110 to send an instruction to each one of student stations 101-103, to stop or pause the learning activity and to display a message such as “Please look at the Board right now” on the student stations 101-103. Other suitable operations and control schemes may be used to allow the teacher station 110 to selectively command the operation of projector 111 and/or board 112.

The teacher station 110, as well as the student stations 101-103, may be connected with a school server 121 able to provide or serve digital content, for example, learning objects, learning activities and/or lessons. Additionally or alternatively, the teacher station 110, as well as the student stations 101-103, may be connected to an educational content repository 122, either directly (e.g., if the educational content repository 122 is part of the school server 121 or associated therewith) or indirectly (e.g., if the educational content repository 122 is implemented using a remote server, using Internet resources, or the like). In some embodiments, system 100 may be implemented such that educational content are stored locally at the school, or in a remote location. For example, a school server may provide full services to the teacher station 110 and/or the student stations 101-103; and/or, the school server may operate as mediator or proxy to a remote server able to serve educational content.

Content development tools 124 may be used, locally or remotely, to generate original or new education content, or to modify or edit or update content items, for example, utilizing templates, editors, step-by-step “wizard” generators, packaging tools, sequencing tools, “wrapping” tools, authoring tools, or the like.

In some embodiments, a remote access sub-system 123 is used, to allow teachers and/or students to utilize remote computing devices (e.g., at home, at a library, or the like) in conjunction with the school server 121 and/or the educational content repository 122.

In some embodiments, the teacher station 110 and the student stations 101-103 may be implemented using a common interface or an integrated platform (e.g., an “educational workstation”), such that a log-in screen request the user to select or otherwise input his role (e.g., teacher or student) and/or identity (e.g., name or unique identifier).

In some embodiments, system 100 performs ongoing assessment of students performance based on their operation of student stations 101-103. For example, instead of or in addition to conventional event-based quizzes or examinations, system 100 monitors the successes and the failures of individual students in individual learning objects or learning activities. For example, the teacher utilizes the teacher station 110 to allocate or distribute various learning activities or learning objects to various students or groups of students. The teacher utilizes the teacher station 110 to allocate a first learning object and a second learning object to a first group of students, including Student A who utilizes student station 101; and the teacher utilizes the teacher station 110 to allocate the first learning object and a third learning object to a second group of students, including Student B who utilizes student station 102.

System 100 monitors, logs and reports the performance of students based on their operation of student stations 101-103. For example, system 100 may determine and report that Student A successfully completed the first learning object, whereas Student B failed to complete the second learning object. System 100 may determine and report that Student A successfully completed the first learning object within a pre-defined time period associated with the first learning object, whereas Student B completed the second learning object within a time period longer than the required time period. System 100 may determine and report that Student A successfully completed or answered 87 percent of tasks or questions in a learning object or a learning activity, whereas Student B successfully completed or answered 45 percent of tasks or questions in a learning object or a learning activity. System 100 may determine and report that Student A successfully completed or answered 80 percent of the tasks or questions in a learning object or a learning activity on his first attempt and 20 percent of tasks or questions only on the second attempt, whereas Student B successfully completed or answered only 29 percent on the first attempt, 31 percent on the second attempt, and for the remaining 40 percent he got the right answer from the student station (e.g., after providing incorrect answers on three attempts). System 100 may determine and report that Student A appears to be “stuck” or lingering on a particular exercise or learning object, or that Student B did not operate the keyboard or mouse for a particular time period (e.g., two minutes). System 100 may determine and report that at least 80 percent of the students in the first group successfully completed at least 75 percent of their allocated learning activity, or that at least 50 percent of the students in the second group failed to correctly answer at least 30 percent of questions allocated to them. Other types of determinations and reports may be used.

System 100 generates reports at various times and using various methods, for example, based on the choice of the teacher utilizing the teacher station 110. For example, the teacher station 110 may generate one or more types of reports, e.g., individual student reports, group reports, class reports, an alert-type message that alerts the teacher to a particular event (e.g., failure or success of a student or a group of students), or the like. Reports may be generated, for example, at the end of a lesson; at particular times (e.g., at a certain hour); at pre-defined time intervals (e.g., every ten minutes, every school-day, every week); upon demand, request or command of a teacher utilizing the teacher station; upon a triggering event or when one or more conditions are met, e.g., upon completion of a certain learning activity by a student or group of students, a student failing a learning activity, a pre-defined percentage of students failing a learning activity, a student succeeding in a learning activity, a pre-defined percentage of students succeeding in a learning activity, or the like.

In some embodiments, reports or alerts may be generated by system 100 substantially in real-time, during the lesson process in class. For example, system 100 may alert the teacher, using a graphical or textual or audible notification through the teacher station 110, that one or more students or groups of students do not progress (at all, or according to pre-defined mile-stones) in the learning activity or learning object assigned to them. Upon receiving the real-time alert, the teacher may utilize the teacher station 110 to further retrieve details of the actual progress, for example, by obtaining detailed information on the progress of the relevant student(s) or group(s). For example, the teacher may use the teacher station 110 to view a report detailing progress status of students, e.g., whether the student started or not yet started a learning object or a learning activity; the percentage of students in the class or in one or more groups that completed as assignment; the progress of students in a learning object or a learning activity (e.g., the student performed 40 percent of the learning activity; the student is “stuck” for more than three minutes in front of the third question or the fourth screen of a learning object; the student completed the assigned learning object, and started to perform an optional learning object), or the like.

In some embodiments, teaching, learning and/or assessment activities are monitored, recorded and stored in a format that allows subsequent searching, querying and retrieval. Data mining processes in combination with reporting tools may perform research and may generate reports on various educational, pedagogic and administrative entities, for example: on students (single student, a group of students, all students in a class, a grade, a school, or the like); teachers (a single teacher, a group of teachers that teach the same grade and/or in the same school and/or the same discipline); learning activities and related content; and for conducting research and formative assessment for improvement of teaching methodologies, flow or sequence of learning activities, or the like.

In some embodiments, data mining processes and analysis processes may be performed, for example, on knowledge maps of students, on the tracked and logged operations that students perform on student stations, on the tracked and logged operations that teachers perform on teacher stations, or the like. The data mining and analysis may determine conclusions with regard to the performance, the achievements, the strengths, the weaknesses, the behavior and/or other properties of one or more students, teachers, classes, groups, schools, school districts, national education systems, multi-national or international education systems, or the like. In some embodiments, analysis results may be used to compare among teaching and/or learning at international level, national level, district level, school level, grade level, class level, group level, student level, or the like.

In some embodiments, the generated repots are used as alternative or additional assessment of students performance, students knowledge, students knowledge, students learning strategies (e.g., a student is always attempting trial and error when answering; a student is always asking the system for the hint option), students classroom behavior (e.g., a student is responsive to instructions, a student is non-responsive to instructions), or other student parameters. In some embodiments, for some assessment events, information items (e.g., “rubrics”) may be created and/or displayed, to provide assessment-related information to the teacher or to the teaching/learning system; the assessment information item may be visible to, or accessible by, the teacher and/or the student (e.g., subject to teacher's authorization). The assessment information item may include, for example, a built-in or integrated information item inside an assessment event that provides instructions to the teacher (or the teaching/learning system) on how to evaluate an assessment event which was executed by the student. Other formats and/or functions of assessment information items may be used.

Optionally, system 100 generates and/or initiates, automatically or upon demand of the teacher utilizing the teacher station 110 (or, for example, automatically and subject to the approval of the teacher utilizing the teacher station 1 10), one or more student-adapted correction cycles, “drilling” cycles, additional learning objects, modified learning objects, or the like. In view of data from of the students' record of performance, system 100 may identify strengths and weaknesses, comprehension and misconceptions. For example, system 100 determines that Student A solved correctly 72 percent of the math questions presented to him; that substantially all (or most of) the math questions that Student A solved successfully are in the field of multiplication; and that substantially all (or most of) the math questions that Student A failed to solved are in the field of division. Accordingly, system 100 may report to the teacher station 110 that Student A comprehends multiplication, and that Student A does not comprehend (at all, or to an estimated degree) division. Additionally, system 100 adaptively and selectively presents content (or refrain from presenting content) to accommodate the identified strengths and weaknesses of Student A. For example, system 100 may selectively refrain from presenting to Student A additional content (e.g., hints, explanations and/or exercises) in the field of multiplication, which Student A comprehends. System 100 may selectively present to Student A additional content (e.g., explanations, examples and/or exercises) in the field of division, which Student B does not yet comprehend. The additional presentation (or the refraining from additional presentation) may be performed by system 100 automatically, or subject to an approval of the teacher utilizing the teacher station 110 in response to an alert message or a suggestion message presented on the teacher station 110.

In some embodiments, if given the appropriate permission(s), multiple types of users may utilize system 100 or its components, in-class and/or remotely. Such types of users include, for example, teachers in class, students in class, teachers at home or remotely, students at home or remotely, parents, community members, supervisors, managers, principals, authorities (e.g., Board of Education), school system administrator, school support and help-desk personnel, system manager(s), techno-pedagogic experts, content development experts, or the like.

In some embodiments, system 100 may be used as a collaborative Learning Management System (LMS), in which teachers and students utilize a common system. For example, system 100 may include collaboration tools 130 to allow real-time in-class collaboration, e.g., allowing students to send or submit their accomplishments or their work results (or portions thereof) to a common space, from which the teacher (utilizing the teacher station 110) selects one or more of the submission items for projection, for comparison, or the like. The collaboration tools 130 may optionally be implemented, for example, using a collaboration environment or collaboration area or collaboration system. The collaboration tools 130 may optionally include a teacher-moderated common space, to which students (utilizing the student stations 101-103) post their work, text, graphics, or other information, thereby creating a common collaborative “blog” or publishing a Web news bulletin or other form of presentation of students products. The collaboration tools 130 may further provide a collaborative workspace, where students may work together on a common assignment, optionally displaying in real-time peers that are available online for chat or instant messaging (e.g., represented using real-life names, user-names, avatars, graphical items, textual items, photographs, links, or the like).

In some embodiments, dynamic personalization and/or differentiation may be used by system 100, for example, per teacher, per student, per group of students, per class, per grade, or the like. System 100 and/or its educational content may be open to third-party content, may comply with various standards (e.g., World Wide Web standards, education standards, or the like). System 100 may be a tagged-content Learning Content Management System (LCMS), utilizing Semantic Web mechanisms, meta-data, tagging content and learning activities by concept-based controlled vocabulary, describing their relations to educational and/or disciplinary concepts, and/or democratic tagging of educational content by users (e.g., teachers, students, experts, parents, or the like).

System 100 may utilize or may include pluggable architecture, for example, a plug-in or converter or importer mechanism, e.g., to allow importing of external materials or content into the system as learning objects or learning activities or lessons, to allow smart retrieval from the content repository, to allow identification by the LMS system and CAA sub-system 170, to allow rapid adaptation of new types of learning objects (e.g., original or third-party), to provide a blueprint or a template for third-party content, or the like.

System 100 may be implemented or adapted to meet specific requirements of an education system or a school. For example, in some embodiments, system 100 may set a maximum number of activities per sequence or per lesson; may set a maximum number of parallel activities that the teacher may allocate to students (e.g., to avoid a situation in which the teacher “loses control” of what each student in the class is doing); may allow flexible navigation within and/or between learning activities and/or learning objects; may include clear, legible and non-artistic interface components, for easier or faster comprehension by users; may allow collaborative discussions among students (or student stations), and/or among one or more students (or student stations) and the teacher (or teacher station); and may train and prepare teacher and students for using the system 100 and for maximizing the benefits from its educational content and tools.

In some embodiments, a student station 101-103 allows the student to access a “user cabinet” or “personal folder” which includes personal information and content associated with that particular student. For example, the “user cabinet” may store and/or present to the student: educational content that the student already viewed or practiced; projects that the student already completed and/or submitted; drafts and work-in-progress that the student prepares, prior to their completion and/or submission; personal records of the student, for example, his grades and his attendance records; copies of tests or assignments that the student already took, optionally reconstructing the test or allowing the test to be re-solved by the student, or optionally showing the correct answers to the test questions; lessons that the student already viewed; tutorials that the student already viewed, or tutorials related to topics that the student already practiced; forward-looking tutorials, lectures and explanations related to topics that the student did not yet learn and/or did not yet practice, but that the student is required to learn by himself or out of class; assignments or homework assignments pending for completion; assignments or homework assignments completed, submitted, graded, and/or still in draft status; a notepad with private or personal notes that the student may write for his retrieval; indications of “bookmarks” or “favorites” or other pointers to learning objects or learning activities or educational content which the student selected to mark as favorite or for rapid access; or the like.

In some embodiments, the teacher station 110 allows the teacher (and optionally one or more students, if given appropriate permission(s), via the student stations) to access a “teacher cabinet” or “personal folder” (or a subset thereof, or a presentation or a display of portions thereof), which may, for example, store and/or present to the teacher (and/or to students) the “plans” or “activity layout” that the teacher planned for his class; changes or additions that the teacher introduced to the original plan; presentation of the actually executed lesson process, optionally including comments that the teacher entered; or the like.

System 100 may utilize Computer-Assisted Assessment or Computer-Aided Assessment (CAA) of performance of student(s) and of pedagogic parameters related to student(s). In some embodiments, for example, system 100 may include, or may be coupled to, a CAA sub-system 170 having multiple components or modules.

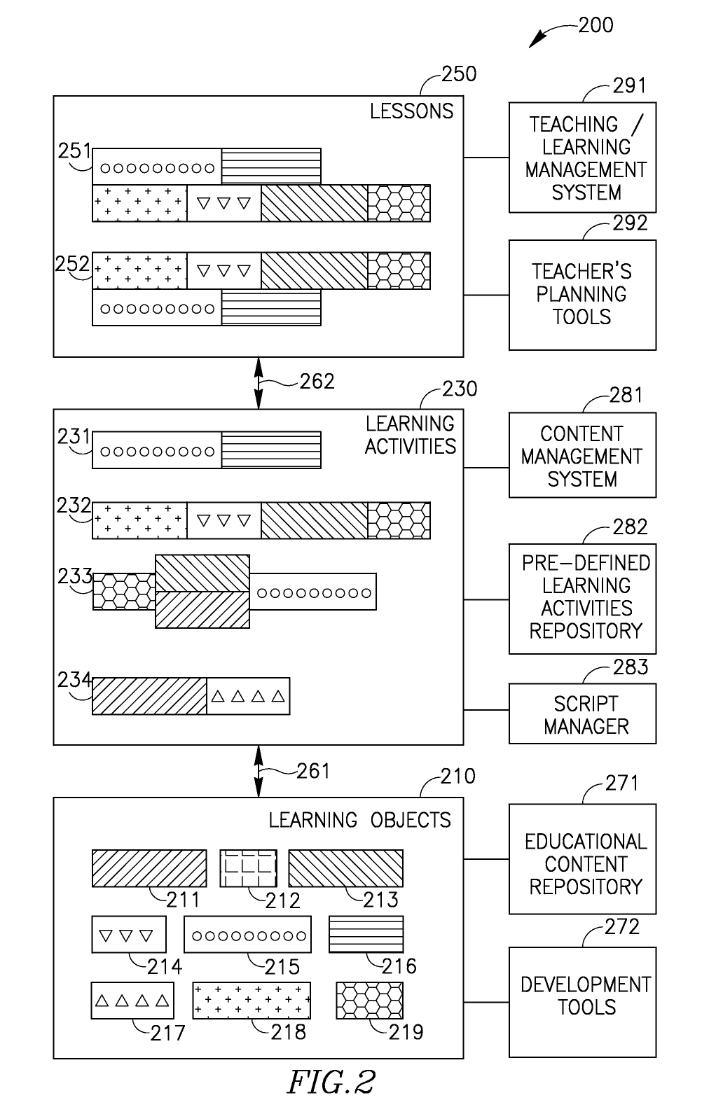

FIG. 2 is a schematic block diagram illustration of a teaching/learning data structure 200 in accordance with some demonstrative embodiments. Data structure 200 includes multiple layers, for example, learning objects 210, learning activities 230, and lessons 250. In some embodiments, the teaching/learning data structure 200 may include other or additional levels of hierarchy; for example, a study unit or a segment may include a collection of multiple lessons that cover a particular topic, issue or subject, e.g., as part of a yearly subject-matter learning/teaching plan. Other or additional levels of hierarchy may be used.

Learning objects 210 include, for example, multiple learning objects 211-219. A learning object includes, for example, a stand-alone application, applet, program, or assignment addressed to a student (or to a group of students), intended for utilization by a student. A learning object may be, for example, subject to viewing, listening, typing, drawing, or otherwise interacting (e.g., passively or actively) by a student utilizing a computer. For example, learning object 211 is an Active-X interactive animated story, in which a student is required to select graphical items using a pointing device; learning object 212 is an audio/video presentation or lecture (e.g., an AVI or MPG or WMV or MOV video file) which is intended for passive viewing/hearing by the student; learning object 213 is a Flash application in which the student is required to move (e.g., drag and drop) graphical object and/or textual objects; learning object 214 is a Java applet in which the student is required to type text in response to questions posed; learning object 215 is a JavaScript program in which the student selects answers in a multiple-choice quiz; learning object 216 is a Dynamic HTML page in which the student is required to read a text, optionally navigating forward and backward among pages; learning object 217 is a Shockwave application in which the student is required to draw geometric shapes in response to instructions; or the like. Learning objects may include various other content items, for example, interactive text or “live text”, writing tools, discussion tools, assignments, tasks, quizzes, games, drills and exercises, problems for solving, questions, instruction pages, lectures, animations, audio/video content, graphical content, textual content, vocabularies, or the like.

Learning objects 210 may be associated with various time-lengths, levels of difficulty, curriculum portions or subjects, or other properties. For example, learning object 211 requires approximately twelve minutes for completion, whereas learning object 212 requires approximately seven minutes for completion; learning object 213 is a difficult learning object, whereas learning object 214 is an easy learning object; learning object 215 is a math learning object, whereas learning object 216 is a literature learning object.

Learning objects 210 are stored in an educational content repository 271. Learning objects 271 are authored, created, developed and/or generated using development tools 272, for example, using templates, editors, authoring tools, a step-by-step “wizard” generation process, or the like. The learning objects 210 are created by one or more of: teachers, teaching professionals, school personnel, pedagogic experts, academy members, principals, consultants, researchers, or other professionals. The learning objects 210 may be created or modified, for example, based on input received from focus groups, experts, simulators, quality assurance teams, or other suitable sources. The learning objects 210 may be imported from external sources, e.g., utilizing a conversion or re-formatting tools. In some embodiments, modification of a learning object by a user may result in a duplication of the learning object, such that both the original unmodified version and the new modified version of the learning object are stored; the original version and the new version of the learning object may be used substantially independently.

Learning activities 230 include, for example, multiple learning activities 231-234. For example, learning activity 231 includes learning object 215, followed by learning object 216. Learning activity 232 includes learning object 218, followed by learning objects 214, 213 and 219. Learning activity 233 includes learning object 233, followed by either learning object 213 or learning object 211, followed by learning object 215. Learning activity 234 includes learning object 211, followed by learning object 217.

A learning activity includes, for example, one or more learning objects in the same (or similar) subject matter (e.g., math, literature, physics, or the like). Learning activities 230 may be associated with various time-lengths, levels of difficulty, curriculum portions or subjects, or other properties. For example, learning activity 231 requires approximately eighteen minutes for completion, whereas learning activity 232 requires approximately thirty minutes for completion; learning activity 232 is a difficult learning activity, whereas learning activity 234 is an easy learning activity; learning activity 231 is a math learning activity, whereas learning activity 232 is a literature learning activity. A learning object may be used or placed at different locations (e.g., time locations) in different learning activities. For example, learning object 215 is the first learning object in learning activity 231, whereas learning object 215 is the last learning object in learning activity 233.

Learning activities 230 are generated and managed by a content management system 281, which may create and/or store learning activities 230. For example, browser interface allows a teacher to browse through learning objects 210 stored in the educational content repository (e.g., sorted or filtered by subject, difficulty level, time length, or other properties), and to select and construct a learning activity by combining one or more learning objects (e.g., using a drag-and-drop interface, a time-line, or other tools). In some embodiments, learning activities 230 can be arranged and/or combined in various teaching-learning-assessment scenarios or layouts, for example, using different methods of organization or modeling methods. Scenarios may be arranged, for example, manually in a pre-defined order; or may be generated automatically utilizing a script to define sequencing, branched sequencing, conditioned sequencing, or the like. Additionally or alternatively, pre-defined learning activities are stored in a pre-defined learning activities repository 282, and are available for utilization by teachers. In some embodiments, an edited scenario or layout, or a teacher generated scenario or layout, are stored in the teacher's personal “cabinet” or “private folder” (e.g., as described herein) and can by recalled for re-use or for modification. In some embodiments, other or additional mechanisms or components may be used, in addition to or instead of the learning activities repository 282. The teaching/learning system provides tools for editing of pre-defined scenarios (e.g., stored in the learning activities repository 282), and/or for creation of new scenarios by the teacher. For example, a script manager 283 may be used to create, modify and/or store scripts which define the components of the learning activity, their order or sequence, an associated time-line, and associated properties (e.g., requirements, conditions, or the like). Optionally, scripts may include rules or scripting commands that allow dynamic modification of the learning activity based on various conditions or contexts, for example, based on past performance of the particular student that uses the learning activity, based on preferences of the particular student that uses the learning activity, based on the phase of the learning process, or the like. Optionally, the script may be part of the teaching/learning plan. Once activated or executed, the script calls the appropriate learning object(s) from the educational content repository 271, and may optionally assign them to students, e.g., differentially or adaptively. The script may be implemented, for example, using Educational Modeling Language (EML), using scripting methods and commands in accordance with IMS Learning Design (LD) specifications and standards, or the like. In some embodiments, the script manager 283 may include an EML editor, thereby integrating EML editing functions into the teaching/learning system. In some embodiments, the teaching/learning system and/or the script manager 283 utilize a “modeling language” and/or “scripting language” that use pedagogic terms, e.g., describing pedagogic events and pedagogic activities that teachers are familiar with. The script may further include specifications as to what type of data should be stored or reported to the teacher substantially in real time, for example, with regard to students interactions or responses to a learning object. For example, the script may indicate to the teaching/learning system to automatically perform one or more of these operations: to store all the results and/or answers provided by students to all the questions, or to a selected group of questions; to store all the choices made by the student, or only the student's last choice; to report in real time to the teacher if pre-defined conditions are true, e.g., if at least 50 percent of the answers of a student are wrong; or the like.

Lessons 250 include, for example, multiple lessons 251 and 252. For example, lesson 251 includes learning activity 231, followed by learning activity 232. Lesson 252 includes learning activity 234, followed by learning activity 231. A lesson includes one or more learning activities, optionally having the same (or similar) subject matter.

For example, learning objects 211 and 217 are in the subject matter of multiplication, whereas learning objects 215 and 216 are in the subject matter of division. Accordingly, learning activity 234 (which includes learning objects 211 and 217) is in the subject matter of multiplication, whereas learning activity 231 (which includes learning objects 215 and 216) is in the subject matter of division. Furthermore, lesson 252 (which includes learning activities 234 and 231) is in the subject matter of math.

Lessons 250 may be associated with various time-lengths, levels of difficulty, curriculum portions or subjects, or other properties. For example, lesson 251 requires approximately forty minutes for completion, whereas lesson 252 requires approximately thirty five for completion; lesson 251 is a difficult lesson, whereas lesson 252 is an easy lesson. A learning activity may be used or placed at different locations (e.g., time locations) in different lessons. For example, learning activity 215 is the first learning object in learning activity 231, whereas learning object 215 is the last learning object in learning activity 233.

Lessons 250 are generated and managed by a teaching/learning management system 291, which may create and/or store lessons 250. For example, browser interface allows a teacher to browse through learning activities 230 (e.g., sorted or filtered by subject, difficulty level, time length, or other properties), and to select and construct a lesson by combining one or more learning activities (e.g., using a drag-and-drop interface, a time-line, or other tools). Additionally or alternatively, pre-defined lessons may be available for utilization by teachers.

As indicated by an arrow 261, learning objects 210 are used for creation and modification of learning activities 230. As indicated by an arrow 262, learning activities are used for creation and modification of lessons 250.

In some embodiments, a large number of learning objects 210 and/or learning activities 230 are available for utilization by teachers. For example, in one embodiment, learning objects 210 may include at least 300 singular learning objects 210 per subject per grade (e.g., for second grade, for third grade, or the like); at least 500 questions or exercises per subject per grade; at least 150 drilling games per subject per grade; at least 250 “live text” activities (per subject per grade) in which students interact with interactive text items; or the like.

Some learning objects 210 are originally created or generated on a singular basis, such that a developer creates a new, unique learning object 210. Other learning objects 210 are generated using templates or generation tools or “wizards”. Still other learning objects 210 are generated by modifying a previously-generated learning object 210, e.g., by replacing text items, by replacing or moving graphical items, or the like.

In some embodiments, one or more learning objects 210 may be used to compose or construct a learning activity; one or more learning activities 230 may be used to compose or construct a lesson 250; one or more lessons may be part of a study unit or an educational topic or subject matter; and one or more study units may be part of an educational discipline, e.g., associated with a work plan.

In some embodiments, learning objects 210, learning activities 230, and/or learning lessons 250, may be concept-tagged based on an ontology. For example, an ontology component may include a concept-based controlled vocabulary (expressed using one or more languages) encompassing the system's terminological knowledge, reflecting the explicit and implicit knowledge present within the system's learning objects. The ontology component may be implemented, for example, as a relational database including tables of concepts and their definitions, terms (e.g., in one or more languages), mappings from terms to concepts, and relationships across concepts. Concepts may include educational objectives, required learning outcomes or standards and milestones to be achieved, items from a revised Bloom Taxonomy, models of cognitive processes, levels of learning activities, complexity of gained competencies, general and subject-specific topics, or the like. The concepts of the ontology may be used as the outcomes for CAA and/or for other applications, for example, planning, search/retrieval, differential lesson generation, or the like. A mapping and tagging component may indicate mapping between the various learning entities to the ontology concepts (e.g., knowledge elements) reflecting the pedagogic values of these learning entities. The mapping may be, for example, one-to-one or one-to-many.

In some embodiments, learning entities may belong to a class or a group from an ordered hierarchy; for example, ordered from the larger to the smaller: discipline, subject area, topic, unit, segment, learning activity, activity item (e.g., Molecular SDLO described herein), atom (e.g., Atomic SDLO described herein), and asset. Other suitable hierarchies may be used.

Referring back to FIG. 1, the educational content repository 122 may store learning objects, learning activities, lessons, or other units representing educational content. In some embodiments, the educational content repository 122 may store atomic Smart Digital Learning Objects (Atomic SDLOs) 191, which may be assembled or otherwise combined into Molecular Smart Digital Learning Objects (Molecular SDLOs) 192.

Each Atomic SDLO 191 may be, for example, a unit of information representing a screen to be presented to a student within an educational task. Each Molecular SDLO 192 may include one or more Atomic SDLOs 191. The Atomic SDLOs 191 may be able to interact among themselves, and/or to interact with a managerial component 193 which may further be included, optionally, in Molecular SDLO 192. In some embodiments, the interaction or performance of a student within one Atomic SDLO 191 (e.g., a screen) of a Molecular SDLO 192 may affect the content and/or characteristics of one or more other Atomic SDLO 191 (e.g., one or more other screens) of that Molecular SDLO 192.

In some embodiments, the educational content repository 122 may further include templates 194, layouts 195, and assets 196 from which educational content items may be dynamically generated, automatically generated, semi-automatically generated (e.g., based on input from a teacher), or otherwise utilized in creation or modification or educational content.

In some embodiments, each Atomic SDLO 191, as well as templates 194, layouts 195 and assets 196, may be concept-tagged based on a pre-defined ontology. For example, an ontology component 171 includes a concept-based controlled vocabulary (expressed using one or more languages) encompassing the system's terminological knowledge, reflecting the explicit and implicit knowledge present within the system's learning objects. The ontology component 171 may be implemented, for example, as a relational database including tables of concepts and their definitions, terms (e.g., in one or more languages), mappings from terms to concepts, and relationships across concepts. Concepts may include educational objectives, required learning outcomes or standards and milestones to be achieved, items from a revised Bloom Taxonomy, models of cognitive processes, levels of learning activities, complexity of gained competencies, general and subject-specific topics, or the like. The concepts of ontology 171 may be used as the outcomes for CAA and/or for other applications, for example, planning, search/retrieval, differential lesson generation, or the like.

A mapping and tagging component 172 indicates mapping between the various learning objects or learning entities (e.g., stored in the educational content repository 122) to the ontology concepts (e.g., knowledge elements) reflecting the pedagogic values of these learning entities. The mapping may be, for example, one-to-one or one-to-many. The mapping may be performed based on input from discipline-specific assessment experts.

In some embodiments, the concept-tagging of templates 194 and layouts 195 for skills and competencies allows the teacher, as well as automated or semi-automated wizards and content generation tools, to perform smart selection of these elements when generating a piece of educational content to serve in the learning process. The tagging may include, for example, tagging for contribution to skill and competencies, tagging for contribution to topic and factual knowledge, or the like.

Given the ontology 171, the tagging of all components and students' knowledge map (e.g., as continuously drawn by the CAA sub-system 170) may be performed in conjunction with SDLO rules and in accordance with a pedagogic schema. The schema, or other learning design script, defines the flow or progress of the learning activity from a pedagogical point of view. The SDLO specification defines the relations and interaction between SDLOs in the system.

In accordance with SDLO architecture, learning objects are composed of Atomic SDLOs 191 that communicate between themselves and with the LMS and create a Molecular SDLO 192 able to report all students' interactions within or between Atomic SDLOs 191 to other Atomic SDLOs 191 and/or to the LMS. The assembly of Atomic SDLOs 191 is governed by a learning design script, optionally utilizing the managerial component 193 of the Molecular SDL 192, which may be pre-set or fixed or conditional (e.g., pre-designed with a predefined path, or develops according to student interaction). In some embodiments, Atomic SDLO 191 may by itself be assembled by a learning design script from assets 196 (e.g., multimedia items and/or textual content).

In some embodiments, a content generation module 197 (e.g., which may optionally be part of the content development tools 124 or other content generation environment or wizard) may assist the teacher to create educational content answering students need as reflected by the CAA sub-system 170, using tagged templates 194, layouts 195 and assets 196. The Atomic SDLO 191 or the Molecular SDLO 192 may be the building block; a conditional learning design script may be used as the “assembler”; and a wizard tool helps the teacher in writing the design script. In some embodiments, the content generation wizard may be implemented as a fully automated tool.

For demonstrative purposes, some Atomic SDLOs 191 and Molecular SDLOs 192 are discussed herein; other suitable combinations may be used in conjunction with some embodiments.

For example, a learning activity may be implemented using a Molecular SDLO 192 which combines two Atomic SDLOs 191 presented side by side, thereby presenting and narrating the text that appears on a first side of the screen, in synchronization with pictures or drawings that appear on a second side of the screen. The images are presented in the order of the development of the story, thereby providing the relevant hints for better understanding of the text. The synchronization means, for example, that if the student commands the student station 101 to “go back”, or “rewinds” the narration of the text, then the images accompanying the text similarly “goes back” or “rewinds” to fit the narration flow.

In another demonstrative example, a “drag and drop” matching question may be implemented as a Molecular SDLO 192. For example, two lists are presented and the student is asked to drag an item from a first list to the appropriate item on the second list. Alternatively, textual elements may be moved and/or graphically organized: the student is asked to mark text portions on one part of the screen, and to drag them into designated areas marked in the other part of the screen. The designated areas are displayed parallel to the text, and are titled or named in a way that describes or hints what part of the text is to be placed in them. The designated areas may optionally be in a form of a question that asks to place appropriate parts of the text as answers, or in the form of a chart that requires putting words or sentences in a specific order, thereby checking the student's understanding of the text. When the student finishes, the system may check the answers and may provide to the student appropriate feedback. Correct answers are marked as correct, while incorrect answers may receive “hints” in form of “comments” or in the text itself by highlighting paragraphs, sentences or words that point the student to relevant parts of the text.

In other demonstrative embodiments, a Molecular SDLO 192 may present an exercise in which the student is asked to fill in blanks. When the student clicks on a blank, the “live text” module (described herein) highlights the entire sentence with the blanks to be filled. If the student cannot type the required words, he may choose to open a “word bank” that presents him with several optional words. The student may then drag the word of his choice to fill in the blank. The “live test” module checks the student's answers and provides supportive feedback. Correct word choices are accepted as correct answers even if they differ from the words used in the original text, and may be marked with a smiley-face. Incorrect answers may get feedback relevant to the type of mistake; for example, misspelled words may trigger a feedback which specifies “incorrect spelling”, whereas grammatical errors may trigger a feedback indicating “incorrect grammar”. Entirely incorrect answers may offer the student to use the “word-bank” and may provide a hint, or may refer the student to re-read the text.

In another demonstrative example, a learning activity asks the student to broaden the text by filling-in complete sentences that show her understanding or interpretations (e.g., describing feelings, explanations, observations, or the like). The blank space may dynamically expand as the student types in her own words. The “live text” module may offer assistance, for example, banks of sentences beginnings, icons, emoticons, or the likes.

In some embodiments, completion questions or open questions may be answered inside the live text portion of the screen, for example, by opening a “free typing” window within the live text or using an external “notepad” outside the live text portion of the screen. For example, the student may be asked a question or assigned a writing assignment; if she needs help, she may activate one or more assistance tools, e.g., lists that suggest words or ideas to use, or a wizard that presents pictures, diagrams or charts that describe the text to clarify its' structure or give ideas for the essay in form of a “story-board”. Upon performing of the filling-in operation, the completion operation, or the typing in response to an “open” question, the student selects a “submit” button in order to send his input to the system for checking and feedback.

In another demonstrative example, a Molecular SDLO 192 may be used for comparing two versions of a story or other text, that are displayed on the screen. Highlighting and marking tools allow the teacher or the student to create a visual comparison, or to “separate” among issues or formats or concepts. In some learning activities, marked elements may be moved or copied to a separate window (e.g., “mark and drag all the sentences that describe thoughts”). Optionally, marking of text portions for comparison may be automatically performed by the linguistic navigator component (described herein), which may highlight textual elements based on selected criteria or properties (e.g., adjectives, emotions, thoughts).

In some embodiments, the student is presented with an activity item, implemented as a Molecular SDLO 192, including a split screen. Half of the screen is presenting an Atomic SDLO 191 showing a piece of text (story, essay, poem, mathematic problem); and the other half of the screen is presenting another Molecular SDLO 192 including a set or sequence of Atomic SDLOs 191 that correspond to a variety of activities, offering different types of interactions that assist the learning process. The activity item may further include: instructions for operation; definitions of step by step advancing process to guide students through the stages of the activity; and buttons or links that call tools, wizard or applets to the screen (if available).

The different Atomic SDLOs 191 that are integrated into a Molecular SDLO 192 may be “interconnected” and can communicate data and/or commands among themselves. For example, when the student performs in one part of the screen, the other part of the screen may respond in many ways: advancing to the next or previous screen in response to correct/incorrect answers; showing relevant information to the student choices; acting upon students requests; or the like.

The different Atomic SDLOs 191 may further communicate data and/or commands to the managerial component 193 which may modify the choice of available screens or the behavior of tools. The Molecular SDLOs 192 may communicate data to the various modules of the LMS such as the CAA sub-system 170 and/or its logger component, its alert generator, and/or its dashboard presentations, as well as to the advancer 181.

In some embodiments, for example, in an activity in the language arts, one part of the screen may present to the student the text that is the base for the learning interactions, and the other part may provide a set of screens having activities and their related learning interactions. The student is asked to read the text, and when he indicates that he is done and ready to proceed, the other part of the screen will offer a set of Atomic SDLOs 191, for example, guiding choice questions, multiple choice questions, matching or other drag-and-drop activities, comparison tasks, closes, or the like.

The questions may be displayed beside the text or story, and are utilized to verify the student's understanding of the text or to further involve the student in activities that enhance this understanding. If the student males a wrong choice or drags an element to a wrong place, the system may highlight the relevant paragraph in the text, thereby “showing” or “hinting” him where to read in order to find the correct answer. If the student chooses a wrong answer for a second time the system may highlight the relevant sentence within the paragraph, focusing him more closely to the right answer. Alternatively, the system may offer the student “smart feedback” to assist him in finding the answer or hints in a variety of formats, for example, audio representation, pictures, or textual explanations. If a third incorrect answer is chosen by the student, the correct answer is displayed to him, for example, on both parts of the screen; in the multiple choice questions area, the correct answer may be marked, and in the text area the correct or relevant word(s) may be highlighted.

At any stage of the activity, the student may call for the available tools, for example, marking tools, a dictionary, a writing pad, the linguistic navigator (described herein), or other tools, and use them before or during answering the questions or performing the task.

When finished with any part of a task, question or assignment, the student may ask the system to check his answers and get feedback. An immediate real-time assessment procedure may execute within the Molecular SDLO 192, and may report assessment results to the student screen as well as to managerial component 193 which in turn may offer the student one or more alternative Atomic SDLOs 191 that were included (e.g., as “hidden” or inactive Atomic SDLOs 191) in the Molecular SDLO 192 and present them to the student according to the rules of the predefined pedagogic predefined schema. For example, if the student fails certain type of activities, he may be offered other types of activities; if the student is a non-reader then she may get the same activity based on narrated text and/or pictures; if the student fails questions that indicate problems in understanding basic issues, he may be re-routed to fundamental explanations; if his answers indicate lack of skills, then he may get exercises to strengthen them; or the like.

When the student's basic understanding of the text is verified, he is assigned more advanced or complicated tasks. These may include, for example, manipulation of the original text, comparison or differentiation between texts, as well as “free-text” or open writing tasks.

One or more of the activity screens may offer open questions or ask for an open writing assignment. A writing area may be opened for the student, and the assisting tools may further include word-banks, opening sentences banks, flow-diagrams, and/or story-board style pictures. In case of open questions or writing assignments, the student may submit his work to the teacher for evaluation, assessment and comments. The teacher's decision may be used by the managerial component 193 and may be entered as a change parameter to the pedagogic schema.

The pedagogic schema may indicate or define the activity as a pre-test or as a formal summative assessment event (post-test). In this case, some (or all) of the assisting tools or forms of feedback may be made unavailable to the student.

In some embodiments, for example, in a mathematics activity, one part of the screen may include the situation or the event that is the base for the learning interactions or for the problem to be solved (e.g., an animated event or a drawing or a textual description); whereas the other part of the screen may include a set or a sequence of Atomic SDLOs 191 having activities, tasks, and learning interactions (e.g., problem solving, exercises, suggesting the next step of action, offering a solution, reasoning a choice, or the like).

Any part of the activity may be a mathematic interaction tool; it may be the main area of activity, instead of the “live text” in the case of language arts. For example, a geometry board may allow drawing of geometric shapes, or another mathematic applet may be used as required by the specific stage of the curriculum (e.g., an applet that allows manipulation of bars to investigate size comparison issues; an applet that serves for graphic presentation of parts of a whole; an applet that serves graphical presentations of equations). These applets may be divided into two parts: a first part that displays the task goals, instructions and optionally its rubrics; and a second part that serves as the activity area and allows performing of the task itself (e.g., manipulating shapes, drawing, performing mathematic operations and transactions). Other Atomic SDLOs 191 may be presented beside the mathematic interaction tool, and they may present guiding questions or may offer a mathematics editor to write equations and solve them. The student may utilize available tools (e.g., calculators or applets), or may request demonstrative examples.

Student's answers may be used, for example, for assessment; to provide feedback and/or hints to the student; to transfer relevant data to the managerial component 193; to amend the pedagogic schema; to modify the choice of alternative Atomic SDLOs 191 from within the Molecular SDLO 192, thereby presenting new activities to the student.

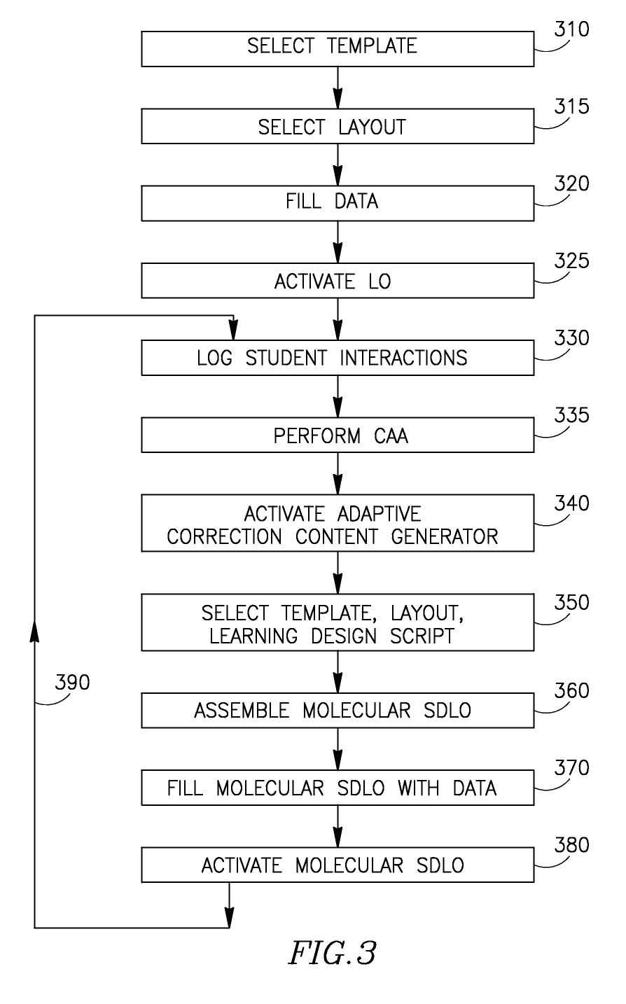

Reference is made to FIG. 3, which is a schematic flow-chart of a method of automated content generation, in accordance with some demonstrative embodiments. Operations of the method may be used, for example, by system 100 of FIG. 1, and/or by other suitable units, devices and/or systems.

In some embodiments, the method may include, for example, selecting a template based on (tagged) contribution to skills and components (block 310).

In some embodiments, the method may include, for example, selecting a layout (block 315) and filling it with data contributing to topic and factual knowledge (block 320). The resulting learning object may be activated (block 325).

In some embodiments, the method may include, for example, logging the interactions of a student who performs the digital learning activity (block 330).

In some embodiments, the method may include, for example, performing CAA to assess the student's knowledge (block 335). For example, the student's progress is compared to, or checked in reference to, the required learning outcome or the required knowledge map. This may include, optionally, generating a report or an alert to the teacher's station based on the CAA results.

In some embodiments, the method may include, for example, activating an adaptive correction content generation tool or wizard (block 340).

In some embodiments, the method may include, for example, selecting a template, a layout, and a learning design script (block 350). This may be performed, for example, by the content generation tool or wizard.

In some embodiments, the method may include, for example, assembling a Molecular SDLO (block 360), e.g., from one or more Atomic SDLOs.

In some embodiments, the method may include, for example, filling the Molecular SDLO with data contributing to topic and factual knowledge (block 370), e.g., optionally taking into account the CAA results. The molecular SDLO may be activated (block 380).

In some embodiments, the method may include, for example, repeating the operations of blocks 330 and onward (arrow 390).

Referring back to FIG. 1, system 100 may utilize educational content items that are modular and re-usable. For example, Atomic SDLO 191 may be used and re-used for assembly of complex Molecular SDLO 192; which in turn may be used and re-used to form a learning unit or learning activity; and multiple learning units or learning activities may form a course or a subject in a discipline.

In some embodiments, rich tagging (e.g., meta-data) attached to or associated with each Atomic SDLO 191 and/or each Molecular SDLO 192 may allow, for example, re-usability, flexibility (“mix and match”), smart search and retrieve, progress monitoring and knowledge mapping, and adaptive learning tasks assignment.

In some embodiments, educational content items may be based on template 194 and layouts 195 and may thus be interchangeable for differential learning. Instances may be created from a “mold”, which uses structured design(s) and/or predefined model(s), and controls the layout, the look-and-feel and the interactive flow on screen (e.g., programmed once but used and re-used many times). Optionally, singular educational content items may be used, after being tailor-made and developed to serve a unique or single learning event or purpose (e.g., a particular animated clip or presentation).

In some embodiments, an Atomic SDLO 191 corresponds to a single screen presented to the student; whereas a Molecular SDLO 192 (or an “activity item”) may include a set of multiple context-related content objects or Atomic SDLOs 191. Optionally, a ruler or bar or other progress indicator may indicate the relative position or progress of the currently-active Atomic SDLO 191 within a Molecular SDLO 192 during playback or performance of that Molecular SDLO 192 (e.g., indicating “screen 3 of 8” when the third Atomic SDLO 191 is active in a set of eight Atomic SDLOs 191 combined into a Molecular SDLO 192).

In some embodiments, content items may have a hierarchy, for example: discipline, subject area, topic, unit, segment, learning activity, activity item (e.g., Molecular SDLO 192), atom (e.g., Atomic SDLO 191), and asset. Each activity item may correspond to a High-Level Task (HLT) which may include one or more Atomic SDLO 191 and/or one or more Molecular SDLO 192 (e.g., corresponding to tasks). Each Molecular SDLO 192, in turn, may include one or more Atomic SDLOs 191. In some embodiments, other types of hierarchy may be used, for example, utilizing HLT, tasks, sub-tasks, tasks embedded within other tasks, Atomic SDLOs 191 included within tasks or sub-tasks, or the like. In some embodiments, a HLT may include other combinations of atomic educational content items and/or tasks. In some embodiments, a HLT may correspond to a digital learning object which communicates with the LMS and manages the screens that are displayed to the student.

Reference is made to FIG. 5, which is a schematic block diagram illustration of tasks management in accordance with some demonstrative embodiments. A first task is implemented using a first Molecular SDLO 510, which includes two Atomic SDLOs 511-512 that are managed using a task manager 515 internal to Molecular SDLO 510. Similarly, a second task is implemented using a second Molecular SDLO 520, which includes three Atomic SDLOs 521-523, that are managed using a task manager 525 internal to Molecular SDLO 520. Optionally, communication between the two Molecular SDLOs 510 and 520 is handled using a task manager 530 external to both of them. In some embodiments, the structure of the two Molecular SDLOs 510 and 520, and their common task manager 530, may correspond to a third task 550, e.g., a High-Level Task (HLT).

In some embodiments, a pedagogical schema is used to define a learning activity from a pedagogical point of view. For example, a “task” specification defines the interaction between SDLOs, and a content developer may define pedagogical tasks. The programmable “tasks” may be based on, for example, a standard for creating tasks composed of one or more Atomic SDLOs, as well as a software component to implement the standard (e.g., both for content feeding and for runtime).

In some embodiments, multi-Molecular SDLOs may be used, or multiple sequences of Atomic SDLOs 191 may be used and presented on one screen; whereas the pedagogic schema may be, for example, a software component that governs the possible relations and interactions among them.

For demonstrative purposes, some components and operations of a “live text” module are described herein; other suitable learning activities may be created using the concepts and components described herein.

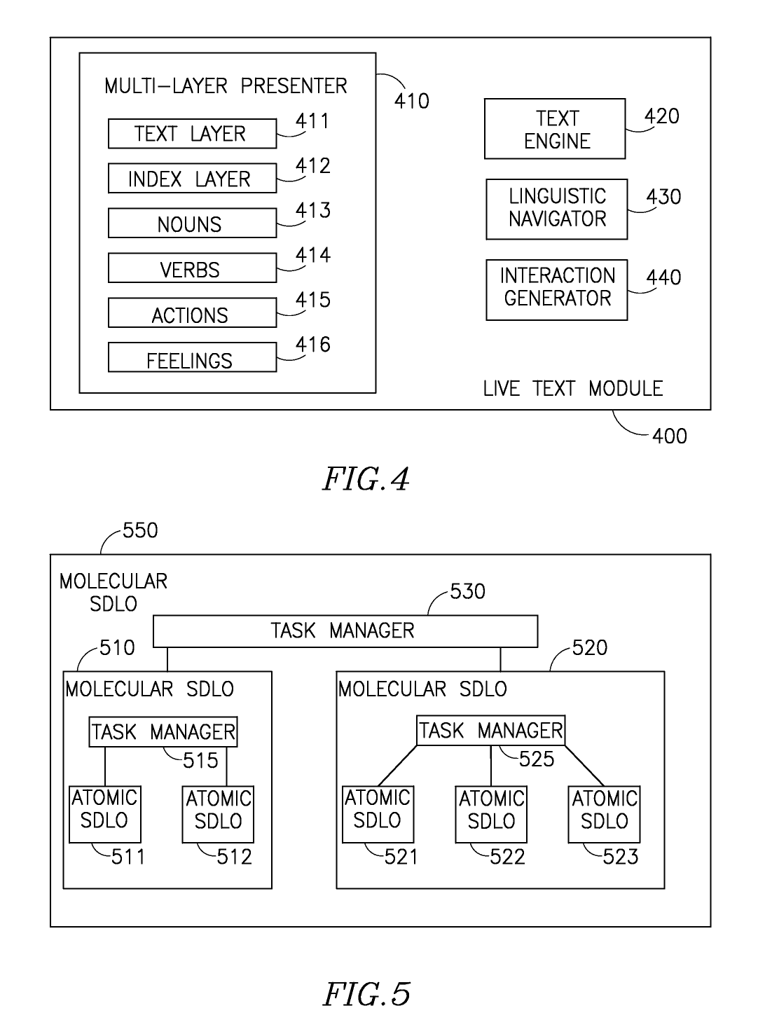

Reference is made to FIG. 4, which is a schematic block diagram illustration of a “live text” module 400 in accordance with some demonstrative embodiments. The “live text” module 400 may be a demonstrative implementation of SDLO architecture, and may be used by system 100 of FIG. 1.

The “live text” module 400 may be a computerized text generator, modifier and presenter, that promotes language and textual abilities. The “live text” module 400 generates text-integrated activities focusing on linguistic phenomena in the text, to enhance reading comprehension and promote language awareness. The rich and diverse activities encourage multi-level learning in a heterogeneous classroom. The textual environment promotes and enhances language abilities and textual skills utilizing tools for: reading comprehension, writing skills, listening comprehension, speaking skills, researching, and presenting.

The “live text” module 400 includes, for example, a multi-layer presenter 410, a text engine 420, a linguistic navigator 430, an interaction generator 440,

The multi-layer presenter 410 is associated with and operates on multiple layers, for example, a text layer 411, an index layer 412, and multiple linguistic analysis layers, e.g., layers 413-416 corresponding to nouns, verbs, actions, feelings, or the like. In some embodiments, thorough indexing of text properties or linguistic properties may be used, for example, to index: letters, words, sentences, and paragraphs; nouns, verbs, adjectives, adverbs; words or sentences that convey facts, words or sentences that convey feelings, words or sentences that convey thoughts; words or sentences in active voice, words or sentences in passive voice; or the like.

The text engine 420 tool allows text manipulation; for example, text components may be moved, emphasized, highlighted, deleted, enlarged, read-out, revised, or otherwise handled. In some embodiments, the text engine 420 may highlight a first type of text components (e.g., verbs) using a first style (e.g., font type, font size, or font color) and may highlight a second type of text components (e.g., nouns) using a second style.

The linguistic navigator 430 allows accessing text components in the different layers by contextual relevancy or by connection or relations to topics and ideas. The linguistic navigator 430 may highlight or emphasize linguistic phenomena, e.g., passive and active voice, or words expressing different emotions; may lead the reader to turning point(s) in the narrative; and/or may spell out the text structure. For example, clicking on a “linguistic navigator” icon may present a menu, with selectable options of “letters and sounds”, “words and terms”, “sentences”, and “paragraphs”. Upon selection of an item from the menu, a sub-menu may optionally present additional selections (e.g., under “words and terms”, selections of “verbs”, “nouns”, “adjectives”, “feelings”, and “thoughts” may be presented). Upon selection of an item, the relevant linguistic phenomena may be highlighted in the text.

The interaction generator 440 allows activities within the text and activities beside the text (related and relevant), and may assess interactions and provide relevant feedback. Activities within the text may include, for example, marking of text portions, editing of text portions (e.g., “replace the word ‘happy’ with a synonym”), writing of text portions (e.g., “explain here why the elephant could not sleep”), or the like. Activities near the text may include, for example, presenting of questions to the student based on the text, requesting the student to drag-and-drop various text-portions (e.g., words or sentences) that meet particular criteria (e.g., convey feelings, convey thoughts, convey happiness), or the like.

In some embodiments, the student may perform writing activity within the actual text presented, thereby simulating an experience of an author and providing a genuine writing experience.

Assistance may be provided to the student utilizing visual aids and/or audible aids and/or graphical or animated components, in addition to or instead of textual assistance.

In some embodiments, the “live text” module 400 allows various types of interaction of a student or a teacher with the text. For example, the “live text” module 400 may present to the student a text, and may instruct the student to click on three verbs; to highlight four nouns; to identify two sentences in the passive voice; to mark a sentence that reflects a thought of a person; to drag-and-drop an “emoticon” (e.g., a smiley face) onto a corresponding sentence or word (e.g., a funny portion of the text); or the like. The “live text” module may optionally interact with a thesaurus. In some embodiments, layers within the “live text” module 400 may interact with other Atomic SDLOs of the system.

Referring back to FIG. 1, the “live text” module 400 of FIG. 4 may be utilized in combination with other SDLOs of system 100. For example, a “live text” applet may be presented together with (e.g., side by side with) an Atomic SDLO of multiple-choice questions that are related to the text shown; or, together with an Atomic SDLO of a diagram applet asking the student to build a diagram related to the text shown (e.g., “enter the number of gifts that the boy received”); or, together with a set of two Atomic SDLOs asking the student to perform two different types of actions (e.g., matching, and writing); or the like.

In some embodiments, Atomic SDLOs 191 may interact among themselves using inter-atom communications (e.g., an output generated by a first Atomic SDLO 191 is used as an input by a second Atomic SDLO 191) and using inter-atom triggers (e.g., trigger-in or trigger-out). Similar interactions may be used among Molecular SDLOs 192.

Optionally, an advancer module 181 may be used for automatically launching or activating a subsequent Atomic SDLO 191 (or Molecular SDLO 191) once a previous Atomic SDLO 191 (or Molecular SDLO 192) terminates. Other types of flows may be controlled using the advancer module 181, or using other mechanisms.

In some embodiments, each task (e.g., Molecular SDLO 192) may include components of a common format. For example, a task structure component may link to the elements of the task (e.g., Atomic SDLOs 191); and a task manager component may handle communications (e.g., requests, triggers), logic or flow (e.g., sequence, exposure order, navigation, activate/deactivate), and data (assessment, state, Atom output(s)). Each task may optionally include, or may be associates with, other components, for example, aids or hints to the student.

Referring to FIG. 4, in the “live text” module 400, one or more portions of the presented text may be highlighted (e.g., using a font size, font color, font type, background color, underline, bold, italics, or the like). In some embodiments, selective highlighting of text portions may be performed, for example, in response to receiving an input from the student; in response to a request from the student to receive a hint or assistance; and/or automatically together with presentation of a question to the student. In some embodiments, highlighting of text portions may be performed by taking into account the known or assessed skills of the student; for example, a student having learning disability may be presented with greater portions of highlighted text, whereas an advanced student may be presented with smaller portions of highlighted text (or vice versa); or, a student having learning disability may be presented with highlighted words or short sentences (e.g., hinting towards the answer more rapidly), whereas an advanced student may be presented with highlighted paragraphs or long sentences (e.g., hinting towards the answer only after reading, review and/or analysis by the student). In some embodiments, students at different levels of achievements may be presented with different levels or portions or sizes of highlighted relevant text.

The “live text” module 400 may be used in conjunction with various types of questions or student interactions, for example, an external interaction, a text-related interaction, an interaction which is aided by the text, or the like.

For example, an external interaction may include a complete question embedded within the live text presented to the student; and the instructions, possible answers and/or hints may be presented to the user similar to presentation of the question exclusively on a screen. Upon presentation of the question, optionally, one or more text portions may be highlighted. The student may read the question, and may optionally read the live text or portions thereof. The student may proceed with providing an answer, receiving feedback to the answer that she provided (e.g., “correct” or “incorrect”), asking for and receiving a hint or assistance, or the like. In some embodiments, one or more tools or buttons allowing the student to interact with the live text may be disabled or hidden.

Alternatively, a text-related interaction may include a question whose answer object(s) are within the live text; the interactive layer may be the response layer, and may have the highest priority among the layers (e.g., hint layer, assistance layer). Upon presentation of the question, optionally, one or more text portions may be highlighted. The student may read the question, and may optionally read the live text or portions thereof. The student's response to the question is conveyed by interacting with the live text, for example, by selecting or marking portions of the live text (e.g., a word, a term, or a sentence); by moving text portions within the live text or from the live text to an external target area (e.g., using drag-and-drop or point-and-click operations); or the like. Feedback is presented to the student's interaction (e.g., “correct”, “partially correct”, or “incorrect”); and optionally, if the student's interaction corresponds to an incorrect answer, the student may be allowed to retry one or more number of tries until success. The tools or buttons associated with handling live text portions (e.g., marking text, moving text, or the like) may be displayed and active so that the student may utilize them throughout the interaction.

Alternatively, an interaction which is aided by the text may include, for example, a question embedded within the live text, associated with hints or responses that are presented using markings or highlights in the text. Upon presentation of the question, optionally, one or more text portions may be highlighted. The student may read the question, and may optionally read the live text or portions thereof. The student may proceed with providing an answer, receiving feedback to the answer that she provided (e.g., “correct” or “incorrect”), asking for and receiving a hint or assistance, or the like. Optionally, if the student's interaction corresponds to an incorrect answer, the student may be allowed to retry one or more number of tries until success. In some embodiments, one or more tools or buttons allowing the student to interact with the live text may be disabled or hidden.

In some embodiments, a Multiple Choice Question (MCQ) may be presented to the student in proximity to live text. Once the student inputs his response, feedback to the student is provided together with modification of the live text, e.g., marking or highlighting of a portion of the text relevant to the feedback.

In some embodiments, a MCQ may be presented to the student in proximity to the live text, and the possible choices of the MCQ may be multiple text-portions, e.g., highlighted using different font colors or types or backgrounds. The student may select an answer by clicking on one of the highlighted text-portions; in some embodiments, the student may be required to click on (or to otherwise select) more than one item or text-portion in order to provide a full or correct answer.

In some embodiments, an open question may be presented to the user in proximity to the live text. Upon submission of the student's typed answer, the live text may be modified, e.g., text-portions may be highlighted, as feedback to the types answer or in associated with other feedback provided to the types answer.

In some embodiments, a fill-in question may be presented to the student in proximity to the live text. The student may type his answer into the relevant field, and/or may drag-and-drop text portions from the live text into the fill-in field.

In some embodiments, a question may utilize the live text as a repository of words (or terms, or sentences) which may be dragged and dropped, e.g., for matching purposes or ordering purposes. The student may drag-and-drop text portions, and may then request feedback for his performance. Correctly placed text portions may be highlighted using a first color (e.g., green), whereas incorrectly placed text portions may be highlighted using a second color (e.g., red) or may be moved back using on-screen animation into their pre-ordering positions for re-ordering by the student.

In some embodiments, ordering or matching questions may utilize the live text as a target. For example, one or more text portions may be presented to the student in proximity to the live text, and the student may perform drag-and-drop operations to move the text portions into pre-defined and marked positions or placeholders within the live text. Alternatively, the student may perform drag-and-drop operations to move the text portions into substantially any location within the live text, and one or more such locations within the live text may correspond to a correct interaction.

In some embodiments, the live text area of the screen may be “folded” or hidden, e.g., temporarily, in order to make room for presentation of other content (e.g., a question, or possible answers). The folded live text may be unfolded or restored by the student using a dedicated button or graphical element.

In some embodiments, system 100 may utilize a set of rules defining the behavior of content items or objects in conjunction with the live text module 400, for example, in contrast to their default behavior. For example, a question object, which is displayed in the upper section of the screen as a default, is displayed on the right side of the live text. A media item (e.g., image, video, or text), which by default may pop up in a dedicated window, may be presented using a text mask overlaid on the dedicated pop-up window or on the live text. Feedback items (e.g., to a student's response) may pop-up in a dedicated window (e.g., foldable) or may be overlaid on the live text. A MCQ may be presented such that one or more selectable responses are clickable items within the live text, optionally utilizing a “submit” button subsequent to selection and prior to providing feedback. Writable text-fields may be embedded within the live text, and may have a pre-fixed size or a dynamically-changing size; optionally, text portions from the live text may be marked and dragged-and-dropped into the writable text field.

Other suitable operations or sets of operations may be used in accordance with some embodiments. Some operations or sets of operations may be repeated, for example, substantially continuously, for a pre-defined number of iterations, or until one or more conditions are met. In some embodiments, some operations may be performed in parallel, in sequence, or in other suitable orders of execution

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Some embodiments may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be or may include an electronic, magnetic, optical, electromagnetic, InfraRed (IR), or semiconductor system (or apparatus or device) or a propagation medium. Some demonstrative examples of a computer-readable medium may include a semiconductor or solid state memory, magnetic tape, a removable computer diskette, a Random Access Memory (RAM), a Read-Only Memory (ROM), a rigid magnetic disk, an optical disk, or the like. Some demonstrative examples of optical disks include Compact Disk-Read-Only Memory (CD-ROM), Compact Disk-Read/Write (CD-R/W), DVD, or the like.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Some embodiments may be implemented by software, by hardware, or by any combination of software and/or hardware as may be suitable for specific applications or in accordance with specific design requirements. Some embodiments may include units and/or sub-units, which may be separate of each other or combined together, in whole or in part, and may be implemented using specific, multi-purpose or general processors or controllers. Some embodiments may include buffers, registers, stacks, storage units and/or memory units, for temporary or long-term storage of data or in order to facilitate the operation of particular implementations.

Some embodiments may be implemented, for example, using a machine-readable medium or article which may store an instruction or a set of instructions that, if executed by a machine, cause the machine to perform a method and/or operations described herein. Such machine may include, for example, any suitable processing platform, computing platform, computing device, processing device, electronic device, electronic system, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments have been illustrated and described herein, many modifications, substitutions, changes, and equivalents may occur to those skilled in the art. Accordingly, the following claims are intended to cover all such modifications, substitutions, changes, and equivalents.

What is claimed is:

1. A system for adaptive computerized teaching, the system comprising:
a computer station to present to a student an interactive digital learning activity based on a structure representing a molecular digital learning object which comprises one or more atomic digital learning objects, wherein at least one action within a first of the atomic digital learning objects modifies performance of a second of the atomic digital learning objects.

2. The system of claim 1, wherein a first atomic digital learning object of said molecular digital learning object is to generate an output to be used as an input of a second atomic digital learning object of said molecular digital learning object.

3. The system of claim 1, wherein a first atomic digital learning object of said molecular digital learning object is to generate an output which triggers activation of a second atomic digital learning object of said molecular digital learning object.

4. The system of claim 1, wherein the molecular digital learning object comprises a managerial component to handle one or more communications among two or more atomic digital learning objects of said molecular digital learning object.

5. The system of claim 1, wherein the molecular digital learning object is a high-level molecular digital learning object comprising two or more molecular digital learning objects.

6. The system of claim 1, further comprising:
a computer-aided assessment module to dynamically assess one or more pedagogic parameters of said student, based on one or more logged interactions of said student via said computer station with one or more digital learning objects; and
an educational content generation module to automatically generate the structure representing said molecular digital learning object, based on an output of said computer-aided assessment module.

7. The system of claim 6, wherein the educational content generation module is to select, based on the output of said computer-aided assessment module, a digital learning object template, a digital learning object layout, and a learning design script; to create said molecular digital learning object from one or more atomic digital learning objects stored in a repository of educational content items; and to insert digital educational content into said molecular digital learning object.

8. The system of claim 6, wherein the educational content generation module is to activate said molecular digital learning object in a correction cycle performed on said computer station associated with said student.

9. The system of claim 6, wherein the educational content generation module is to automatically insert digital educational content into said molecular digital learning object based on estimated contribution of the inserted digital educational content to topic-related knowledge of said student.

10. The system of claim 9, wherein the educational content generation module is to select said digital educational content based on tagging of atomic digital learning objects with tags of a concept-based ontology.

11. The system of claim 6, wherein the educational content generation module is to select, based on concept-based ontology tags: a digital learning object template, a digital learning object layout, and a learning design script; to generate said molecular digital learning object; and to insert digital educational content into said molecular digital learning object based on estimated contribution of the inserted digital educational content to development of at least one of: a skill of said student, and a competency of said student.

12. An apparatus for adaptive computerized teaching, the apparatus comprising:
a live text module comprising a multi-layer presenter associated with a text layer and an index layer, wherein the index layer comprises an index of said text layer,
wherein the multi-layer presenter is further associated with one or more information layers associated with said text,
wherein the multi-layer presenter is to selectively present at least a portion of said text layer based on said index layer and based on one or more parameters corresponding to said one or more information layers.

13. The apparatus of claim 12, wherein the live text module comprises an atomic digital learning object, and wherein said atomic digital learning object and at least one more atomic digital learning object are comprised in a molecular digital learning object.

14. The apparatus of claim 13, wherein said atomic digital learning object is able to communicate with said at least one more atomic digital learning object.

15. The apparatus of claim 13, wherein said atomic digital learning object is to be managed by a managerial component of said molecular digital learning object.

16. The apparatus of claim 13, wherein said atomic digital learning object is tagged with one or more tags of a concept-based ontology, and wherein said atomic digital learning object is inserted into said molecular digital learning object based on at least one of said tags.

17. The apparatus of claim 12, comprising:
a text engine to selectively present, using an emphasizing style, a portion of said text layer corresponding to a textual characteristic.

18. The apparatus of claim 12, comprising:
a linguistic navigator to present one or more cascading menus comprising selectable menu items, wherein at least one of the menu items corresponds to a linguistic phenomena.

19. The apparatus of claim 18, wherein the linguistic navigator is to present a menu comprising at least one of:
a command to emphasize all words in said text layer which meet a selectable linguistic property;
a command to emphasize all terms in said text layer which meet a selectable linguistic property;
a command to emphasize all sentences in said text layer which meet a selectable linguistic property;
a command to emphasize all paragraphs in said text layer which meet a selectable linguistic property;
a command to emphasize all text-portions in said text layer which meet a selectable grammar-related property; and
a command to emphasize all text-portions in said text layer which meet a selectable vocabulary-related property;

20. The apparatus of claim 18, wherein the linguistic navigator is to present a menu comprising at least one of:
a command to emphasize verbs in said text layer,
a command to emphasize nouns in said text layer,
a command to emphasize adverbs in said text layer,
a command to emphasize adjectives in said text layer,
a command to emphasize questions in said text layer,
a command to emphasize thoughts in said text layer,
a command to emphasize feelings in said text layer,
a command to emphasize actions in said text layer,
a command to emphasize past-time portions in said text layer,
a command to emphasize present-time portions in said text layer, and
a command to emphasize future-time portions in said text layer.

21. The apparatus of claim 12, comprising:
an interaction generator to generate an interaction between a student utilizing a student station and said text layer.

22. The apparatus of claim 21, wherein the interaction comprises an interaction selected from the group consisting of:
ordering of text portions,
dragging and dropping of text portions,
matching among text portions,
moving a text portion into a type-in field, and
moving into said text layer a text portion external to said text layer.

23. A method of adaptive computerized teaching, the method comprising:
presenting to a student an interactive digital learning activity based on a structure representing a molecular digital learning object which comprises one or more atomic digital learning objects, wherein at least one action within a first of the atomic digital learning objects modifies performance of a second of the atomic digital learning objects.

24. The method of claim 23, wherein a first atomic digital learning object of said molecular digital learning object is to generate an output to be used as an input of a second atomic digital learning object of said molecular digital learning object.

25. The method of claim 23, wherein a first atomic digital learning object of said molecular digital learning object is to generate an output which triggers activation of a second atomic digital learning object of said molecular digital learning object.

26. The method of claim 23, comprising:
operating a managerial component of the molecular digital learning object to handle one or more communications among two or more atomic digital learning objects of said molecular digital learning object.

27. The method of claim 23, wherein the molecular digital learning object is a high-level molecular digital learning object comprising two or more molecular digital learning objects.

28. The method of claim 23, further comprising:
dynamically assessing one or more pedagogic parameters of said student, based on one or more logged interactions of said student via said computer station with one or more digital learning objects; and
automatically generating the structure representing said molecular digital learning object, based on an output of said computer-aided assessment module.

29. The method of claim 28, comprising:
based on the results of the assessing, selecting a digital learning object template, a digital learning object layout, and a learning design script;
creating said molecular digital learning object from one or more atomic digital learning objects stored in a repository of educational content items; and
inserting digital educational content into said molecular digital learning object.

30. The method of claim 28, comprising:
activating said molecular digital learning object in a correction cycle performed on said computer station associated with said student.

31. The method of claim 28, comprising:
automatically inserting digital educational content into said molecular digital learning object based on estimated contribution of the inserted digital educational content to topic-related knowledge of said student.

32. The method of claim 31, comprising:
selecting said digital educational content based on tagging of atomic digital learning objects with tags of a concept-based ontology.

33. The method of claim 28, comprising:
based on concept-based ontology tags, selecting: a digital learning object template, a digital learning object layout, and a learning design script;
generating said molecular digital learning object; and
inserting digital educational content into said molecular digital learning object based on estimated contribution of the inserted digital educational content to development of at least one of: a skill of said student, and a competency of said student.
